(19) United States
(12) Patent Application Publication
(10) Pub. No.: US 2007/0142976 A1
(43) Pub. Date: Jun. 21, 2007

(54) Electronic apparatus and thermal control method of electronic apparatus

(76) Inventor: Koji Tezuka, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/640,573

(22) Filed: Dec. 18, 2006

(30) Foreign Application Priority Data
Dec. 19, 2005 (JP) P2005-364843

(51) Int. Cl. G05D 23/00

(52) U.S. Cl. 700/300

(57) ABSTRACT

According to one embodiment, there is provided an electronic apparatus including: a main body configured to be used in a first mode and a second mode; a fan installed in the main body; a control section that controls the fan on the basis of a detected acceleration of the main body, the detected temperature inside of the main body, and the selected mode. The control section includes: a storage that stores a first setting for controlling the fan in a first temperature range and a second setting for controlling the fan in a second temperature range that includes a temperature range lower than the first temperature range; and a setting select section that selects one setting among the first and second setting.

### CROSS-REFERENCE TO RELATED APPLICATIONS

This application is based upon and claims the benefit of priority from Japanese Patent Application No. 2005-364843, filed Dec. 19, 2005, the entire contents of which are incorporated herein by reference.

### BACKGROUND

1. Field

One embodiment of the invention relates to an electronic apparatus and a thermal control method of an electronic apparatus.

2. Description of the Related Art

Being easily moved or carried, electronic apparatus such as notebook personal computers are used being placed on the lap of a user as well as on a desk or the like. However, since such electronic apparatus incorporate heating components such as a CPU and a graphic controller in a thin cabinet, heat tends to be confined in the cabinet and a user sometimes feels his or her lap being heated by such an electronic apparatus in operation placed thereon. Then, such electronic apparatus are required to control the temperature of the cabinet bottom surface so as not to cause a user to feel his or her lap being heated. For example, such a control is performed by letting heat out of the cabinet with a fan installed therein.

However, when such an electronic apparatus is used in a state that the electronic apparatus is placed on a desk rather than the lap of a user, the user dose not feel himself or herself heated. Therefore, when the fan rotation start temperature is set the same as in the case where such an electronic apparatus is placed on the lap of a user though the electronic apparatus is actually placed on a desk, unnecessary fan rotation is caused to waste electric power. In contrast, for example, Japanese Patent Application Publication (KOKAI) No. 2000-242369, Japanese Patent Application Publication (KOKAI) No. 2003-345465 or U.S. Pat. No. 6,760,649 discloses a technique that makes it possible to properly control the temperature inside of an electronic apparatus by determining its state of use, that is, whether the electronic apparatus is placed on a desk or the lap of a user.

However, the above related technique is such that the temperature control mode is switched by detecting strain through force acting on the cabinet or detecting pressure acting on a computer housing. An erroneous operation may occur depending on how a user uses an electronic apparatus. For example, the user may feel himself or herself heated though the electronic apparatus is placed on his or her lap because of a failure to detect stress or pressure, or the fan is rotated uselessly though the electronic apparatus is placed on a desk because of erroneous detection of stress or pressure.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of an electronic apparatus according to embodiments of the present invention;

FIG. 2 is an exemplary simplified functional block diagram of an electronic apparatus according to a first embodiment of the present invention;

FIG. 3 is an exemplary conceptual diagram showing a relationship between temperature settings of a first temperature control table and a second temperature control table which are used in the electronic apparatus according to the first embodiment;

FIG. 4 is an exemplary flowchart showing the workings of the electronic apparatus according to the first embodiment;

FIG. 5 is an exemplary simplified functional block diagram of an electronic apparatus according to a second embodiment of the present invention;

FIG. 6 is an exemplary conceptual diagram showing a relationship between temperature settings of a first temperature control table and a second temperature control table which are used in the electronic apparatus according to the second embodiment; and

FIG. 7 is an exemplary flowchart showing the workings of the electronic apparatus according to the second embodiment.

### DETAILED DESCRIPTION

Various embodiments according to the invention will be described hereinafter with reference to the accompanying drawings. In general, according to one embodiment of the invention, there is provided an electronic apparatus including: a main body that is configured to be used in a first mode and a secondmode; an acceleration sensor that detects an acceleration of the main body; a temperature sensor that detects temperature inside of the main body; a fan installed in the main body; a mode select section that allows a user to select one mode from the first mode and the second mode; and a control section that controls the fan on the basis of the detected acceleration, the detected temperature, and the selected mode. The control section includes: a storage that stores a first setting for controlling the fan in a first temperature range and a second setting for controlling the fan in a second temperature range that includes a temperature range lower than the first temperature range; and a setting select section that selects the first setting when the detected acceleration is lower than a threshold level, selects the first setting when the detected acceleration is higher than or equal to the threshold level while the first mode is selected, and selects the second setting when the detected acceleration is higher than or equal to the threshold level while the second mode is selected.

### First Embodiment

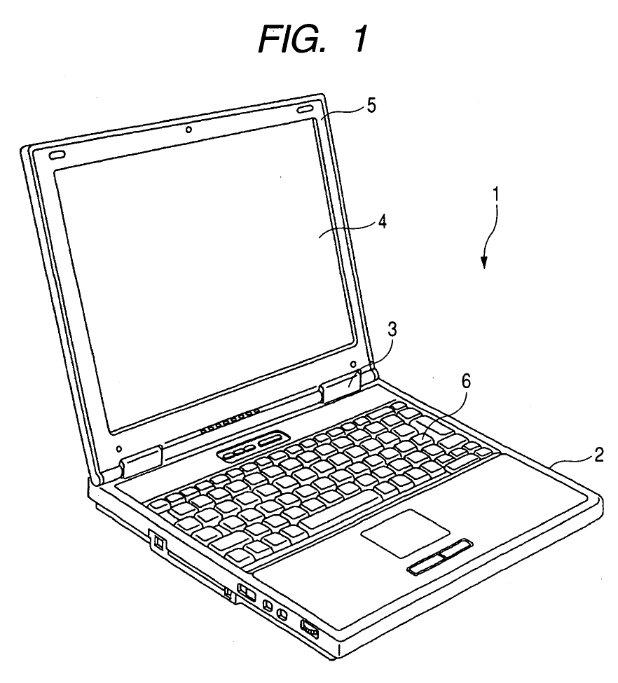

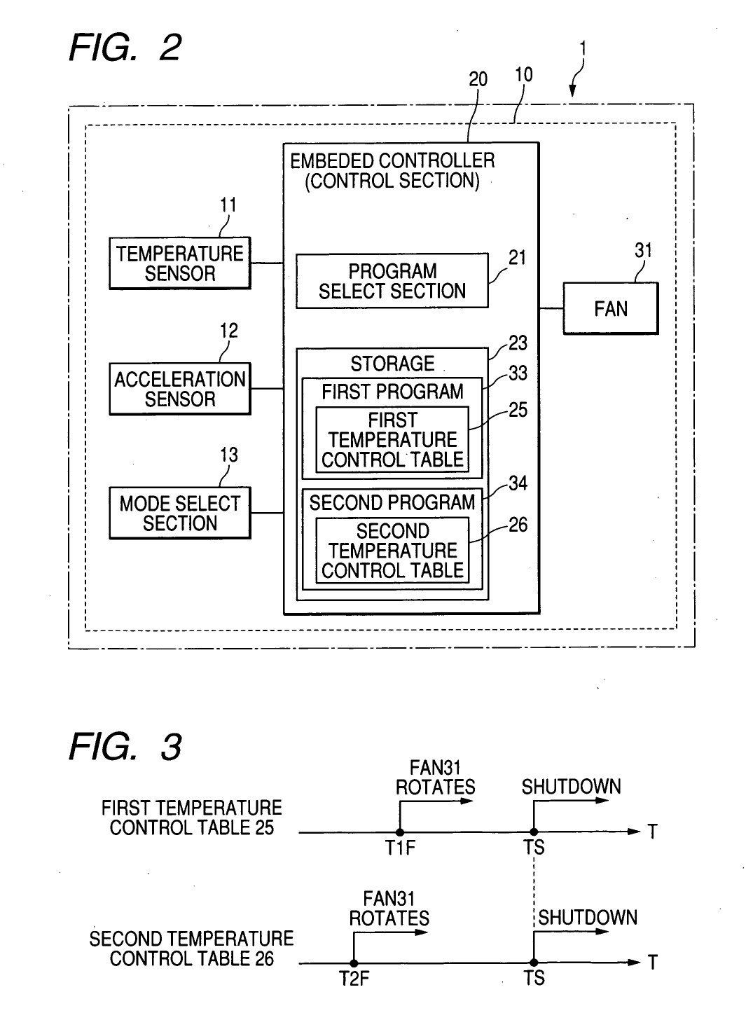

FIG. 1 is a perspective view of an electronic apparatus according to a first embodiment of the invention. FIG. 2 is a simplified functional block diagram of the electronic apparatus according to the first embodiment of the invention.

Although the electronic apparatus 1 shown in FIG. 1 is a notebook personal computer, the invention is also applicable to a laptop personal computer. In the electronic apparatus 1, a lid body equipped with a display unit 4 such as a display panel is connected to a cabinet 2 (main body) via hinge unit 3. The cabinet 2 incorporates a CPU, a graphic controller, etc. and a keyboard 6 as an input unit is provided on the top surface of the cabinet 2.

A thermal control system 10 is provided inside the cabinet 2 of the electronic apparatus 1. The thermal control system 10 is configured as shown in the functional block diagram of FIG. 2 in a simplified manner. The thermal control system 10 is provided with an embedded controller 20 as a control section that performs a rotation control on a fan 31 and a shutdown control on the electronic apparatus 1. A temperature sensor 11, an acceleration sensor 12, a mode select section 13, and the fan 31 are connected to the embedded controller 20.

The acceleration sensor 12 detects the acceleration of the electronic apparatus 1 in each of three orthogonal directions (X-axis, Y-axis, and Z-axis directions).

The temperature sensor 11 that detects the temperature inside of the electronic apparatus 1 is a thermistor or the like. The temperature sensor 11 is usually disposed in the vicinity of the CPU or the graphic controller.

The fan 31 that cools the inside of the electronic apparatus 1 is usually disposed inside the cabinet 2 of the electronic apparatus 1 in the vicinity of an air outlet formed in a side wall of the cabinet 2.

The mode select section 13 that selects a first mode or a second mode as a use mode of the electronic apparatus 1 switches the mode in response to a manipulation of a button provided outside the electronic apparatus 1 or clicking of an icon on the screen.

The first mode is a use mode (also called “on-board mode”) in which an operation of lowering the temperature inside of the electronic apparatus 1 by rotating the fan 31 is not performed even when detected acceleration A is higher than or equal to a movement-determining acceleration (threshold level) AM and a detected temperature T detected by the temperature sensor 11 is higher than or equal to a prescribed temperature. The first mode is a mode that is employed when the electronic apparatus 1 is placed on a table or the like provided in an automobile or a train rather than on the lap of a user. In the first mode, the temperature of the bottom surface of the electronic apparatus 1 becomes higher than in an ordinary mode. However, power is not consumed or the performance is not lowered by, for example, unnecessary rotation of the fan 31 for lowering the temperature of the bottom surface of the electronic apparatus 1, and hence a user can work comfortably in a state that the electronic apparatus 1 exhibits high performance.

The second mode is a use mode (also called “ordinary mode”) in which an operation of lowering the temperature inside of the electronic apparatus 1 by rotating the fan 31 is performed when acceleration A detected by the acceleration sensor 12 is higher than or equal to the movement-determining acceleration AM and a detected temperature T detected by the temperature sensor 11 is higher than or equal to the prescribed temperature. The second mode is a mode that is employed when the electronic apparatus 1 is placed on the lap of a user. In the second mode, power is consumed and the performance is somewhat lowered by, for example, rotation of the fan 13. However, a user can work comfortably without feeling his or her lap being heated by the bottom surface of the electronic apparatus 1.

The movement-determining acceleration AM is a threshold value to be used for determining whether the electronic apparatus 1 is moving. A determination result “the electronic apparatus 1 is moving” is produced when acceleration A is higher than or equal to the movement-determining acceleration AM. The movement-determining acceleration AM may be set as appropriate.

The embedded controller 20 performs a rotation control on the fan 31 and a shutdown control on the electronic apparatus 1 according to a preset first program (first setting) 33 or second program (second setting) 34 receiving detected acceleration A detected by the acceleration sensor 12 and a detected temperature T detected by the temperature sensor 11.

The embedded controller 20 incorporates a program select section (setting select section) 21, which is implemented as a CPU (not shown) of the embedded controller 20.

The program select section 21 performs a control so as to select the first program 33 when the detected acceleration A detected by the acceleration sensor 12 is lower than the movement-determining acceleration AM.

The program select section 21 is also performs a control so as to determine whether the use mode of the electronic apparatus 1 is the first mode (on-board mode) or the second mode (ordinary mode) when the detected acceleration A detected by the acceleration sensor 12 is higher than or equal to the movement-determining acceleration AM, and to select the first program 33 when the use mode is the first mode and the second program 34 when the use mode is the second mode. For example, the program select section 21 is implemented as a register.

In the thermal control system 10 of the electronic apparatus 1 according to the first embodiment, a first temperature control table 25 is set in the first program 33. The first temperature control table 25 contains parameters that are set so that a rotation control is performed on the fan 31 on the basis of a detected temperature T. More specifically, the first temperature control table 25 contains parameters that are set so that the fan 31 is rotated when a detected temperature T is higher than or equal to a first rotation temperature T1F.

The first program 33 is stored in a storage 23. The embedded controller 20 performs a rotation control on the fan 31 according to the first temperature control table 25 set in the first program 33 on the basis of detected acceleration A detected by the acceleration sensor 12, a detected temperature T detected by the temperature sensor 11, and, if necessary, a user mode selected by the mode select section 13.

In the thermal control system 10 of the electronic apparatus 1 according to the first embodiment, a second temperature control table 26 is set in the second program 34. The second temperature control table 26 contains parameters that are set so that a rotation control is performed on the fan 31 on the basis of a detected temperature T, that is, so that a rotation control is performed on the fan 31 even when the detected temperature T is lower than the control temperature range corresponding to the first temperature control table 25 set in the first program 33.

More specifically, the second temperature control table 26 contains parameters that are set so that the fan 31 is rotated when a detected temperature T is higher than or equal to a second rotation temperature T2F which is lower than the first rotation temperature T1F.

The second program 34 is stored in the storage 23. The embedded controller 20 performs a rotation control on the fan 31 according to the second temperature control table 26 set in the second program 34 on the basis of the detected acceleration A detected by the acceleration sensor 12, the detected temperature T detected by the temperature sensor 11 and a user mode selected by the mode select section 13.

A relationship between the temperature settings of the first temperature control table 25 and the second temperature control table 26 will be described below with reference to FIG. 3. FIG. 3 is a conceptual diagram showing the relationship between the temperature settings of the first temperature control table 25 and the second temperature control table 26. As shown in FIG. 3, the first temperature control table 25 serves to rotate the fan 31 when a detected temperature T is higher than or equal to the first rotation temperature T1F and the second temperature control table 26 serves to rotate the fan 31 when a detected temperature T is higher than or equal to the second rotation temperature T2F which is lower than the first rotation temperature T1F.

The storage 23 that stores the first program 33 and the second program 34 is usually implanted as a read-only storage memory (ROM).

The first program 33 or the second program 34 stored in the storage 23 is retrieved selectively according to an instruction from the program select section 21. The embedded controller 20 can perform a rotation control on the fan 31 according to the called first program 33 or second program 34.

The first temperature control table 25, which is set in the first program 33, may cause a shutdown control in addition to a temperature control on the fan 31. For example, the first temperature control table 25 may contain-parameters that are set so that the fan 31 is rotated when a detected temperature T is higher than or equal to the first rotation temperature T1F, and that the electronic apparatus 1 is shut down when the detected temperature T is higher than or equal to a shutdown temperature TS.

The second temperature control table 26, which is set in the second program 34, may cause a shutdown control in addition to a temperature control on the fan 31. For example, the second temperature control table 25 may contain parameters that are set so that the fan 31 is rotated when a detected temperature T is higher than or equal to the second rotation temperature T2F which is lower than the first rotation temperature T1F, and that the electronic apparatus 1 is shut down when a detected temperature T is higher than or equal to the shutdown temperature TS.

As shown in FIG. 3, the shutdown temperature TS, which is set if necessary, is usually set at the same value in the first temperature control table 25 and the second temperature control table 26.

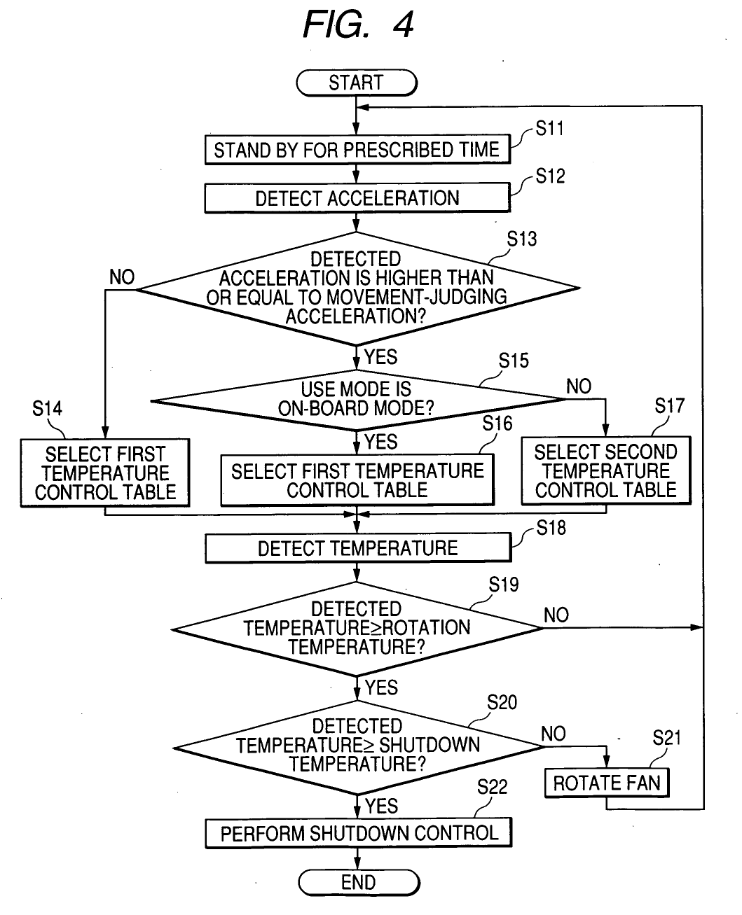

Next, the workings of the electronic apparatus 1 according to the first embodiment of the invention will be described. FIG. 4 is a flowchart showing the workings of the thermal control system 10 of the electronic apparatus 1 according to the first embodiment of the invention.

In the thermal control system 10 of the electronic apparatus 1, upon the start of a thermal control on the electronic apparatus 1, the embedded controller 20 stands by for a prescribed time at block S11 and the acceleration sensor 12 detects acceleration of the electronic apparatus 1 at block S12.

At block S13, the embedded controller 20 compares detected acceleration A detected by the acceleration sensor 12 with the movement-determining acceleration AM.

When the detected acceleration A is lower than the movement-determining acceleration AM, at block S14 the program select section 21 selects the first temperature control table 25 which is set in the first program 33. When the detected acceleration A is lower than the movement-determining acceleration AM, it is not determined whether the use mode of the electronic apparatus 1 is the first mode (on-board mode) or the second mode (ordinary mode).

The first temperature control table 25 of the thermal control system 10 of the electronic apparatus 1 according to the first embodiment contains parameters that are set so that a rotation control is performed on the fan 31 on the basis of a detected temperature T.

More specifically, the first temperature control table 25 contains parameters that are set so that the fan 31 is rotated when a detected temperature T detected by the temperature sensor 11 is higher than or equal to the first rotation temperature T1F. The first temperature control table 25 may be set so that the electronic apparatus 1 is shut down when a detected temperature T is higher than or equal to the shutdown temperature TS.

On the other hand, when the detected acceleration A is higher than or equal to the movement-determining acceleration AM, at block S15 the program select section 21 determines whether the use mode of the electronic apparatus 1 is the first mode (on-board mode) or the second mode (ordinary mode).

When the detected acceleration A is higher than or equal to the movement-determining acceleration AM and the use mode is the first mode (on-board mode), at block S16 the program select section 21 selects the first temperature control table 25.

On the other hand, when the detected acceleration A is higher than or equal to the movement-determining acceleration AM and the use mode is the second mode (ordinary mode), at block S17 the program select section 21 selects the second temperature control table 26 which is set in the second program 34.

The second temperature control table 26 of the thermal control system 10 of the electronic apparatus 1 according to the first embodiment contains parameters that are set so that a rotation control is performed on the fan 31 on the basis of a detected temperature T, that is, so that a rotation control is performed on the fan 31 even when the detected temperature T is lower than the control temperature range corresponding to the first temperature control table 25.

More specifically, the second temperature control table 26 contains parameters that are set so that the fan 31 is rotated when a detected temperature T is higher than or equal to the second rotation temperature T2F which is lower than the first rotation temperature T1F. The second temperature control table 26 may be set so that the electronic apparatus 1 is shut down when a detected temperature T is higher than or equal to the shutdown temperature TS.

At block S18, the temperature sensor 11 detects the temperature inside of the electronic apparatus 1 and the embedded controller 20 employs this temperature as a detected temperature T.

The embedded controller 20 performs a rotation control on the fan 31 according to the selected first program 33 or second program 34.

More specifically, when the first temperature control table 25 which is set in the first program 33 is selected, at block S19 the embedded controller 20 determines whether the detected temperature T is higher than or equal to the first rotation temperature T1F. When the second temperature control table 26 which is set in the first program 34 is selected, at block S19 the embedded controller 20 determines whether the detected temperature T is higher than or equal to the second rotation temperature T2F.

When the first temperature control table 25 is selected and the detected temperature T is lower than the first rotation temperature T1F or when the second temperature control table 26 is selected and the detected temperature T is lower than the second rotation temperature T2F, the embedded controller 20 does not perform a rotation control on the fan 31 or a shutdown control on the electronic apparatus 1 and stands by at block S11.

On the other hand, when the first temperature control table 25 is selected and the detected temperature T is higher than or equal to the first rotation temperature T1F or when the second temperature control table 26 is selected and the detected temperature T is higher than or equal to the second rotation temperature T2F, at block S20 the embedded controller 20 compares the detected temperature T with the shutdown temperature TS.

When the detected temperature T is lower than the shutdown temperature TS, at block S21 the embedded controller 20 starts rotating the fan 31.

On the other hand, when the detected temperature T is higher than or equal to the shutdown temperature TS, at block S22 the embedded controller 20 performs a shutdown control on the electronic apparatus 1.

In the thermal control system 10 of the electronic apparatus 1 according to the first embodiment, the state of use of the electronic apparatus 1, that is, whether it is placed on the lap of a user or a desk (or table), is determined by combining acceleration which is detected by the acceleration sensor 12 and hence is objective information and a use mode which is selected by a user subjectively. This makes it possible to control the temperature of the cabinet 2 properly in accordance of the state of use of the electronic apparatus 1.

In the thermal control system 10, the embedded controller 20 performs a rotation control on the fan 31. However, if necessary, the quantity of heat generated by the CPU or the graphic controller may be reduced by decreasing the clock frequency of the CPU or the graphic controller.

### Second Embodiment

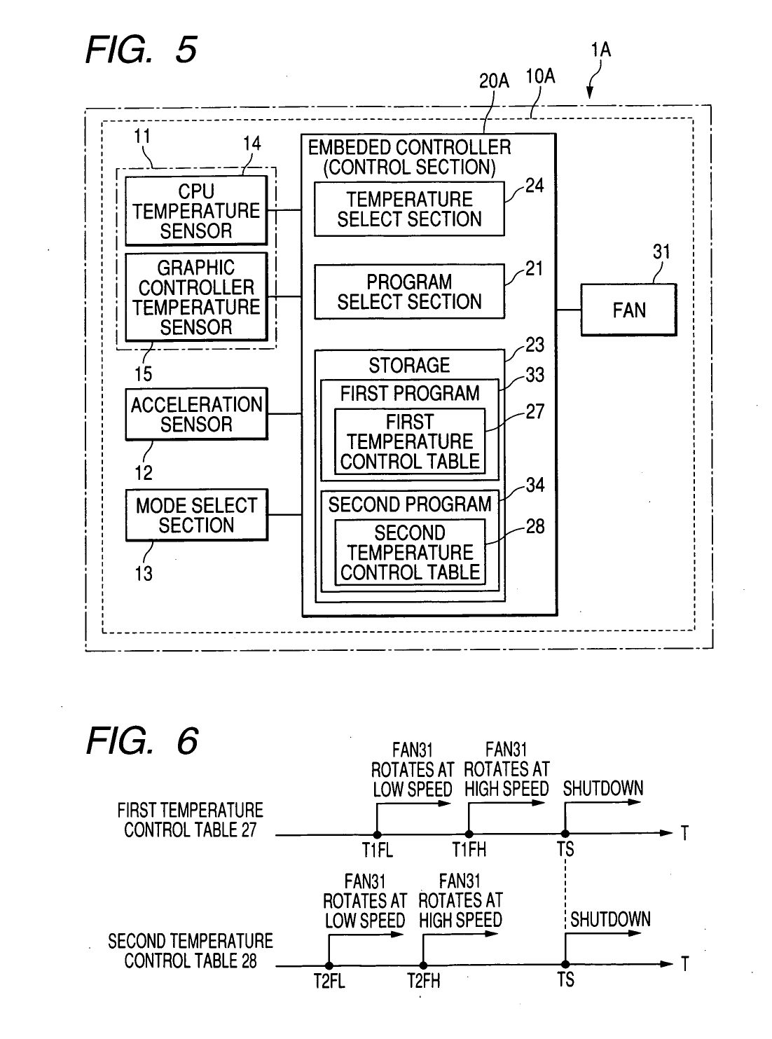

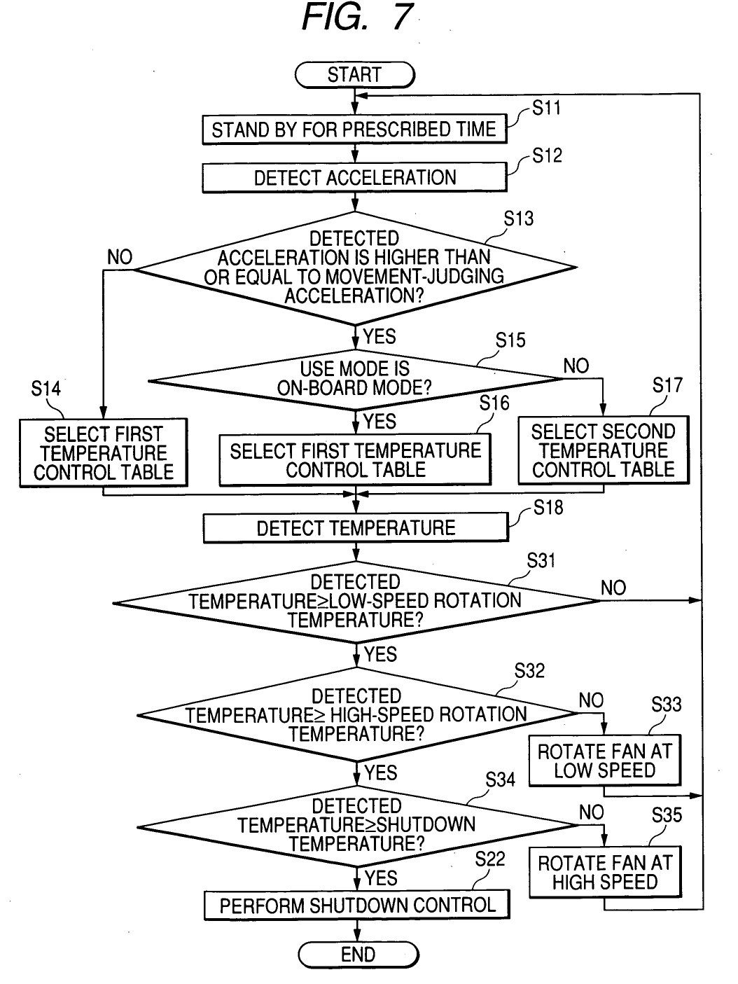

Next, an electronic apparatus according to a second embodiment of the invention will be described with reference to FIG. 5.

The electronic apparatus 1A according to the second embodiment is different from the electronic apparatus 1 according to the first embodiment in that the electronic apparatus 1A incorporates a thermal control system 10A. The electronic apparatus 1A according to the second embodiment is the same in appearance as the electronic apparatus 1 according to the first embodiment and hence appearance of the electronic apparatus 1A is not shown.

The thermal control system 110 incorporated in the electronic apparatus 1A according to the second embodiment is different from the thermal control system 10 incorporated in the electronic apparatus 1 according to the first embodiment in that a temperature sensor 11 consists of a CPU temperature sensor 14 and a graphic controller temperature sensor 15, that an embedded controller 20A is provided with a temperature select section 24, and that a first temperature control table 27 and a second temperature control table 28 that are set in a first program 33 and a second program 34 stored in the embedded controller 20A, respectively, are subdivided to enable a closer rotation control on the fan 31. In the other points, the configuration and the workings of the thermal control system 10A incorporated in the electronic apparatus 1A according to the second embodiment are the same as those of the thermal control system 10 incorporated in the electronic apparatus 1 according to the first embodiment. Therefore, components of the thermal control system 10A having corresponding components in the thermal control system 10 are given the same reference symbols as the latter and will be described in a simplified manner or will not be described at all.

In the thermal control system 10A of the electronic apparatus 1A according to the second embodiment, the embedded controller 20A incorporates the temperature select section 24, the program select section 21, and the storage 23, which are implemented as or cooperate with a CPU (not shown) of the embedded controller 20.

When the temperature sensor 11 which is connected to the temperature select section 24 includes plural temperature sensors, the temperature select section 24. selects a highest one of temperatures detected by the plural temperature sensors and causes the embedded controller 20A to operate on the basis of the highest temperature selected.

In the thermal control system 10A of the electronic apparatus 1A according to the second embodiment, the temperature sensor 11 includes the CPU temperature sensor 14 and the graphic controller temperature sensor 15. The CPU temperature sensor 14 is disposed in the vicinity of the CPU and the graphic controller temperature sensor 15 is disposed in the vicinity of the graphic controller.

The CPU temperature sensor 14 and the graphic controller temperature sensor 15 are connected to the embedded controller 20A. The temperature select section 24 of the embedded controller 20A selects, as a detected temperature T, a higher one of a temperature TC detected by the CPU temperature sensor 14 and a temperature TG detected by the graphic controller temperature sensor 15.

In the thermal control system 10A of the electronic apparatus 1A according to the second embodiment, the first temperature control table 27 set in the first program 33 contains parameters that are set so that a rotation control is performed on the fan 31 on the basis of a detected temperature T. More specifically, the first temperature control table 27 contains parameters that are set so that the fan 31 is rotated at a low speed when a detected temperature T is higher than or equal to a first low-speed rotation temperature T1FL and at a high speed when a detected temperature T is higher than or equal to a first high-speed rotation temperature T1FH which is higher than the first low-speed rotation temperature T1FL.

The first temperature control table 27 of the thermal control system 10A of the electronic apparatus 1A according to the second embodiment is a subdivided version of the first temperature control table 25 of the thermal control system 10 of the electronic apparatus 1 according to the first embodiment. Like the first temperature control table 25 of the first embodiment, the first temperature control table 27 of the second embodiment is stored in the storage 23.

In the thermal control system 10A of the electronic apparatus 1A, the second temperature control table 28 set in the second program 34 contains parameters that are set so that a rotation control is performed on the fan 31 on the basis of a detected temperature T, that is, so that a rotation control is performed on the fan 31 even when the detected temperature T is lower than the control temperature range corresponding to the first temperature control table 27 set in the first program 33.

More specifically, the second temperature control table 28 contains parameters that are set so that the fan 31 is rotated at a low speed when a detected temperature T is higher than or equal to a second low-speed rotation temperature T2FL which is lower than the first low-speed rotation temperature T1FL and the fan 31 is rotated at a high speed when a detected temperature T is higher than or equal to a second high-speed rotation temperature T2FH which is higher than the second low-speed rotation temperature T2FL and lower than the first high-speed rotation temperature T1FH. The second low-speed rotation temperature T2FL and the second high-speed rotation temperature T2FH of the second temperature control table 28 are lower than the first low-speed rotation temperature T1FL and the first high-speed rotation temperature T1FH of the first temperature control table 27, respectively.

The second temperature control table 28 of the thermal control system 10A of the electronic apparatus 1A according to the second embodiment is a subdivided version of the second temperature control table 26 of the thermal control system 10 of the electronic apparatus 1 according to the first embodiment. Like the second temperature control table 26 of the first embodiment, the second temperature control table 28 of the second embodiment is stored in the storage 23.

A relationship between the temperature settings of the first temperature control table 27 and the second temperature control table 28 will be described below with reference to FIG. 6. FIG. 6 is a conceptual diagram showing the relationship between temperature settings of the first temperature control table 27 and the second temperature control table 28. As shown in FIG. 6, the first temperature control table 27 serves to rotate the fan 31 at a low speed when a detected temperature T is higher than or equal to the first low-speed rotation temperature T1FL and the second temperature control table 28 serves to rotate the fan 31 at a low speed when a detected temperature T is higher than or equal to the second low-speed rotation temperature T2FL which is lower than the first low-speed rotation temperature T1FL.

Furthermore, the first temperature control table 27 serves to rotate the fan 31 at a high speed when a detected temperature T is higher than or equal to the first high-speed rotation temperature T1FH and the second temperature control table 28 serves to rotate the fan 31 at a high speed when a detected temperature T is higher than or equal to the second high-speed rotation temperature T2FH which is lower than the first high-speed rotation temperature T1FH.

The first temperature control table 27 may be such as to cause a shutdown control in addition to a temperature control on the fan 31. For example, the first temperature control table 27 may contain parameters that are set so that the fan 31 is rotated at a low speed when a detected temperature T is higher than or equal to the first low-speed rotation temperature T1FL, that the fan 31 is rotated at a high speed when a detected temperature T is higher than or equal to the first high-speed rotation temperature T1FH, and that the electronic apparatus 1 is shut down when a detected temperature T is higher than or equal to a shutdown temperature TS.

The second temperature control table 28 may be such as to cause a shutdown control in addition to a temperature control on the fan 31. For example, the second temperature control table 28 may contain parameters that are set so that the fan 31 is rotated at a low speed when a detected temperature T is higher than or equal to the second low-speed rotation temperature T2FL which is lower than the first low-speed rotation temperature T1FL, that the fan 31 is rotated at a high speed when a detected temperature T is higher than or equal to the second high-speed rotation temperature T2FH which is lower than the first high-speed rotation temperature TLFH, and that the electronic apparatus 1 is shut down when a detected temperature T is higher than or equal to the shutdown temperature TS.

As shown in FIG. 6, the shutdown temperature TS, which is set if necessary, is usually set at the same value in the first temperature control table 27 and the second temperature control table 28.

Next, the workings of the electronic apparatus 1 according to the first embodiment of the invention will be described. FIG. 4 is a flowchart showing the workings of the thermal control system 10A of the electronic apparatus 1A according to the second embodiment of the invention.

The thermal control system 10A of the electronic apparatus 1A according to the second embodiment are the same as the thermal control system 10 of the electronic apparatus 1 according to the first embodiment except for the above-described three features. Therefore, workings of the former that are same as corresponding workings of the latter will be described in a simplified manner or will not be described at all.

The workings of the thermal control system 10A of the electronic apparatus 1A according to the second embodiment are the same as those of the thermal control system 10 of the electronic apparatus 1 according to the first embodiment as far as blocks S11-S13 are concerned, and hence these blocks will not be described.

In the thermal control system 10A of the electronic apparatus 1A according to the second embodiment, after the execution of block S13 of the thermal control system 10 of the electronic apparatus 1 according to the first embodiment, when the detected acceleration A is lower than the movement-determining acceleration AM, at block S14 the program select section 21 selects the first temperature control table 27 which is set in the first program 33. When the detected acceleration A is lower than the movement-determining acceleration AM, it is not determined whether the use mode of the electronic apparatus 1A is the first mode (on-board mode) or the second mode (ordinary mode).

The first temperature control table 27 of the thermal control system 10A of the electronic apparatus 1A according to the second embodiment contains parameters that are set so that a rotation control is performed on the fan 31 on the basis of a detected temperature T. More specifically, the first temperature control table 27 contains parameters that are set so that the fan 31 is rotated at a low speed when a detected temperature T detected by the temperature sensor 11 is higher than or equal to the first low-speed rotation temperature T1FL, and that the fan 31 is rotated at a high speed when a detected temperature T is higher than or equal to the first high-speed rotation temperature T1FH. It is assumed that the first temperature control table 27 is set so that the electronic apparatus 1 is shut down when a detected temperature T is higher than or equal to the shutdown temperature TS.

On the other hand, when the detected acceleration A is higher than or equal to the movement-determining acceleration AM, at block S15 the program select section 21 determines whether the use mode of the electronic apparatus 1A is the first mode (on-board mode) or the second mode (ordinary mode).

When the detected acceleration A is higher than or equal to the movement-determining acceleration AM and the use mode is the first mode (on-board mode), at block S16 the program select section 21 selects the first temperature control table 27 which is set in the first program 33.

On the other hand, when the detected acceleration A is higher than or equal to the movement-determining acceleration AM and the use mode is the second mode (ordinary mode), at block S17 the program select section 21 selects the second temperature control table 26 which is set in the second program 34.

The second temperature control table 28 of the thermal control system 10A of the electronic apparatus 1A according to the second embodiment contains parameters that are set so that a rotation control is performed on the fan 31 on the basis of a detected temperature T, that is, so that a rotation control is performed on the fan 31 even when the detected temperature T is lower than the control temperature range corresponding to the first temperature control table 27.

More specifically, the second temperature control table 28 contains parameters that are set so that the fan 31 is rotated at a low speed when a detected temperature T is higher than or equal to the second low-speed rotation temperature T2FL which is lower than the first low-speed rotation temperature T1FL, and that the fan 31 is rotated at a high speed when a detected temperature T is higher than or equal to the second high-speed rotation temperature T2FH which is lower than the first high-speed rotation temperature T1FH. That is, the second low-speed rotation temperature T2FL and the second high-speed rotation temperature T2FH of the second temperature control table 28 are lower than the first low-speed rotation temperature T1FL and the first high-speed rotation temperature T1FH of the first temperature control table 27. The second temperature control table 28 may be set so that the electronic apparatus 1 is shut down when a detected temperature T is higher than or equal to the shutdown temperature TS.

At block S18, the CPU temperature sensor 14 detects a temperature TC at the position close to the CPU and the graphic controller temperature sensor 15 detects a temperature TG at the position close to the graphic controller. The embedded controller 20A, more specifically, the temperature select section 24, employs a higher one of the temperatures TC and TG as a detected temperature T.

The embedded controller 20 performs a rotation control on the fan 31 according to the selected one of the first temperature control table 27 and the second temperature control table 28 that are set in the first program 33 and the second program 34, respectively.

More specifically, when the first temperature control table 27 is selected, at block S31 the embedded controller 20A determines whether the detected temperature T is higher than or equal to the first low-speed rotation temperature T1FL. When the second temperature control table 28 is selected, at block S31 the embedded controller 20 determines whether the detected temperature T is higher than or equal to the second low-speed rotation temperature T2FL.

When the first temperature control table 27 is selected and the detected temperature T is lower than the first low-speed rotation temperature T1FL or when the second temperature control table 28 is selected and the detected temperature T is lower than the second low-speed rotation temperature T2FL, the embedded controller 20A does not perform a rotation control on the fan 31 or a shutdown control on the electronic apparatus 1A and stands by at block S11.

On the other hand, when the first temperature control table 27 is selected and the detected temperature T is higher than or equal to the first low-speed rotation temperature T1FL, at block S32 the embedded controller 20A determines whether the detected temperature T is higher than or equal to the first high-speed rotation temperature T1FL. When the second temperature control table 28 is selected and the detected temperature T is higher than or equal to the second low-speed rotation temperature T2FL, at block S32 the embedded controller 20A determines whether the detected temperature T is higher than or equal to the second high-speed rotation temperature T2FL.

When the first temperature control table 27 is selected and the detected temperature T is lower than the first high-speed rotation temperature T1FH or when the second temperature control table 28 is selected and the detected temperature T is lower than the second high-speed rotation temperature T2FH, at block S33 the embedded controller 20A starts rotating the fan 31 at a low speed.

When the first temperature control table 27 is selected and the detected temperature T is higher than or equal to the first high-speed rotation temperature T1FH or when the second temperature control table 28 is selected and the detected temperature T is higher than or equal to the second high-speed rotation temperature T2FH, at block S34 the embedded controller 20A compares the detected temperature T with the shutdown temperature TS.

When the detected temperature T is lower than the shutdown temperature TS, at block S35 the embedded controller 20A starts rotating the fan 31 at a high speed.

On the other hand, when the detected temperature T is higher than or equal to the shutdown temperature TS, at block S22 the embedded controller 20A performs a shutdown control on the electronic apparatus 1A.

In the thermal control system 10A of the electronic apparatus 1A according to the second embodiment, the temperature sensor 11 consists of the CPU temperature sensor 14 and the graphic controller temperature sensor 15, the embedded controller 20A is provided with the temperature select section 24, and the first temperature control table 27 and the second temperature control table 28 which are set in the first program 33 and the second program 34 are subdivided to enable a closer rotation control on the fan 31 than in the thermal control system 10 of the electronic apparatus 1. In addition to the advantages of the thermal control system 10 of the electronic apparatus 1, the thermal control system 10A of the electronic apparatus 1A provides advantages that a thermal control on the electronic apparatus 1A can be started when at least one of the CPU temperature sensor 14 and the graphic controller temperature sensor 15 detects a high temperature and that a closer rotation control can be performed on the fan 31.

In the thermal control system 10A of the electronic apparatus 1A according to the second embodiment, the embedded controller 20A performs a rotation control on the fan 31. However, if necessary, the quantity of heat generated by the CPU or the graphic controller may be reduced by decreasing the clock frequency of at least one of the CPU and the graphic controller.

The invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all the components disclosed in the embodiments. Further, components in different embodiments may be appropriately combined.

What is claimed is:

1. An electronic apparatus comprising:
a main body that is configured to be used in a first mode and a second mode;
an acceleration sensor that detects an acceleration of the main body;
a temperature sensor that detects temperature inside of the main body;
a fan installed in the main body;
a mode select section that allows a user to select one mode from the first mode and the second mode; and
a control section that controls the fan on the basis of the detected acceleration, the detected temperature, and the selected mode, the control section comprising:
a storage that stores a first setting for controlling the fan in a first temperature range and a second setting for controlling the fan in a second temperature range that includes a temperature range lower than the first temperature range; and
a setting select section that
(i) selects the first setting when the detected acceleration is lower than a threshold level,
(ii) selects the first setting when the detected acceleration is higher than or equal to the threshold level while the first mode is selected, and
(iii) selects the second setting when the detected acceleration is higher than or equal to the threshold level while the second mode is selected.

2. The electronic apparatus according to claim 1,
wherein the main body is provided with a CPU and a graphic controller,
wherein the temperature sensor comprises:
a CPU temperature sensor that detects a peripheral temperature of the CPU; and
a graphic controller temperature sensor that detects a peripheral temperature of the graphic controller, and
wherein the control section further comprises a temperature select section that selects a higher temperature among the detected peripheral temperature of the CPU and the detected peripheral temperature of the graphic controller to be used for the selection by the setting select section.

3. The electronic apparatus according to claim 1, wherein each of the first setting and the second setting is set so as to rotate the fan at a low speed when the detected temperature is higher than or equal to a low-speed rotation temperature and at a high speed when the detected temperature is higher than or equal to a high-speed rotation temperature, and
wherein the low-speed rotation temperature and the high-speed rotation temperature of the second setting are lower than the low-speed rotation temperature and the high-speed rotation temperature of the first setting, respectively.

4. A thermal control method of an electronic apparatus comprising:
detecting an acceleration of the electronic apparatus by an acceleration sensor;
comparing the detected acceleration with a threshold level;
selecting a first setting that is set so as to control a fan installed in the electronic apparatus in a prescribed temperature range when the detected acceleration is lower than the threshold level;
determining whether a use mode of the electronic apparatus is a first mode or a second mode when the detected acceleration is higher than or equal to the threshold level;
selecting the first setting when the detected acceleration is higher than or equal to the threshold level while it is determined that the user mode is the first mode;
selecting a second setting that is set so as to control the fan in a temperature range including a range that is lower than the prescribed temperature range set in the first setting, when the detected acceleration is higher than or equal to the threshold level while it is determined that the use mode is the second mode;
detecting a temperature inside of the main body by a temperature sensor; and
controlling the fan according to the selected first setting or second setting on the basis of the detected temperature.

5. The control method of the electronic apparatus according to claim 4,
wherein each of the first setting and the second setting is set so as to rotate the fan at a low speed when the detected temperature is higher than or equal to a low-speed rotation temperature and at a high speed when the detected temperature is higher than or equal to a high-speed rotation temperature, and
wherein the low-speed rotation temperature and the high-speed-rotation temperature of the second setting are lower than the low-speed rotation temperature and the high-speed rotation temperature of the first setting, respectively.

6. A thermal control method of an electronic apparatus comprising:
detecting an acceleration of the electronic apparatus by an acceleration sensor;
comparing the detected acceleration with a threshold level;
selecting a first setting that is set so as to control a fan installed in the electronic apparatus in a prescribed temperature range when the detected acceleration is lower than the threshold level;
determining whether a use mode of the electronic apparatus is a first mode or a second mode when the detected acceleration is higher than or equal to the threshold level;
selecting the first setting when the detected acceleration is higher than or equal to the threshold level while it is determined that the use mode is the first mode;
selecting a second setting which is set so as to control the fan in a temperature range including a range that is lower than the prescribed temperature range set in the first setting, when the detected acceleration is higher than or equal to the threshold level while it is determined that the use mode is the second mode;
detecting a peripheral temperature of a CPU with a CPU temperature sensor, detecting a peripheral temperature of a graphic controller with a graphic controller temperature sensor, and selecting a higher temperature among the detected peripheral temperature of the CPU and the detected peripheral temperature of the graphic controller; and
controlling the fan according to the selected first setting or second setting on the basis of the selected higher temperature.

7. The control method of the electronic apparatus according to claim 6,
wherein each of the first setting and the second setting is set so as to rotate the fan at a low speed when the detected temperature is higher than or equal to a low-speed rotation temperature and at a high speed when the detected temperature is higher than or equal to a high-speed rotation temperature; and
wherein the low-speed rotation temperature and the high-speed rotation temperature of the second setting are lower than the low-speed rotation temperature and high-speed rotation temperature of the first setting, respectively.
